(19) United States
(12) Patent Application Publication
(10) Pub. No.: US 2011/0320332 A1
(43) Pub. Date: Dec. 29, 2011

(54) Farmland commoditization and contract fulfillment system

(76) Inventor: Paul V. Kanitra, Greensboro, GA (US)

(21) Appl. No.: 12/322,666

(22) Filed: Feb. 5, 2009

(51) Int. Cl. G06Q 40/00

(52) U.S. Cl. 705/37

(57) ABSTRACT

A system for commoditizing farmland, for fulfilling futures contracts and for the settlement of farmland futures contracts. The system is a computerized system that includes software code that inputs selected soil data for a tract of land, inputs property boundary line data defining a parcel within the tract of land, overlays the soil data over a selected parcel, analyzes land quality measures based upon the overlay of the soil data with the boundary line data, classifies the parcel based upon the result of the analysis of land quality measures, and assigns a size designation to the parcel.

### FIELD OF THE INVENTION

The present invention relates to the field of futures contracts and, in particular, to systems for commoditizing, and fulfilling futures contracts in, farmland.

### BACKGROUND OF THE INVENTION

Commodity futures have, over the last 40 years, broadened greatly from their traditional roots. Agricultural commodities were the first markets that were standardized into futures contracts. These so called agricultural commodities grew to include products as diverse as corn, soybeans, cattle, hogs, cotton, sugar, orange juice, lumber, etc, etc. The success of many of these contracts related directly to industry needs for a viable hedging instrument. Price volatility of the underlying commodity spurred not only hedging strategies but also increased speculative interests. Volatility and risk transference were significant factors behind the proliferation of non-agricultural contacts seen in the more current era. We now have metal and petroleum futures, interest rate futures, currency futures and equity index futures. More recently in the futures markets there have been attempts to develop residential home prices index contracts, commercial real estate indices contracts, weather contracts and even economic event contracts.

A futures contract is a type of financial contract, sometimes referred to as a derivative instrument, in which two parties agree upon the terms of a transaction for the purchase and sale of a commodity for future delivery at a particular price; i.e. a person buying a futures contract is agreeing to buy something that a seller will deliver in the future. In such contracts, the party who agrees to deliver a commodity is said to have taken the “short position”, while the party who agrees to receive the commodity is said to have taken the “long position”. Both long and short positions in a futures contract represent a contractual obligation to fulfillment of the underlying contract specifications. In most cases however, particularly those involving a physical delivery the overwhelming majority of contracts are closed prior to expiration. Buyers and sellers in the futures market typically enter into futures contracts to hedge risk, speculate or as an investment alternative, without the intent to actually exchange the commodity.

In a futures contract, every aspect of the transaction is specified, including the quantity and quality of the commodity, date and method of delivery and all other needed specifics to standardize the contract. This “standardization” of the commodity allows the buyer and seller to focus on a determination of what is the “cheapest to deliver” and price the contract accordingly. Because the person taking the long position does not usually have the opportunity to actually inspect the commodity before entering into the contract, this standardization of the commodity is one of the most important aspects of a futures contract. For example, in a futures contract for the sale of corn, the corn may be specified as being U.S. Grade 2 corn or better. This means that the person taking the short position must deliver corn that meets this grade requirement and cannot deliver corn of a lesser grade, which it could purchase at a lower price prior to the time of delivery. The United States Department of Agriculture has developed detailed grading standards for all types of agricultural commodities and routinely inspects these commodities to ensure that they are properly graded. Similarly, for other commodities with futures contracts that physical settle, there are contractually defined delivery standards that ensure that the long knows the existence of a minimum standard that a prudent short would most likely tender for delivery.

The need to define the quality of a commodity has heretofore prevented the trading of futures in any type of actual real land. Land has traditionally been viewed as unique and incapable of being defined in generic terms that could be specific enough to be commoditized. Accordingly, the market for land has heretofore depended upon individualized transactions between willing buyers and sellers, which have resulted in no readily available hedging instrument, illiquidity of holdings, lack of a generic settlement contract, no public display of closing prices, significant price uncertainty, and the inability to infuse additional capital into the system. For these reasons, owners of sizable tracts of land could greatly benefit from the creation of a liquid market for land. Similarly, large commercial farming companies who expect to purchase additional farmland in the future would benefit from the ability to hedge their risk that the cost of a certain quality of farmland will increase. Large homebuilders that maintain inventories of land that may be used as farmland could also hedge their exposure. The home building industry problem may well have been exasperated in the current housing crisis due to a lack a viable method of hedging. The same industry could further use buy hedge techniques in an expected rising market when the builder has inadequate inventory. Finally, investors could benefit greatly from the ability to participate in the market for farmland without having to actually purchase or sell land.

Unquestionably real estate has become an asset class that is no longer confined to institutional allocations but is now part of individual portfolios. Investors (institutional and individual) making real estate decisions could find benefits as farmland futures participants vs. direct ownership. Land speculators would further benefit with the advent of a farmland futures contract. A controlled, monitored, liquid, margined market removed from potential abuses in the traditional markets reduces the risk to all. There is a definite need for a system for commoditizing farmland that will support a system for trading futures contracts for the purchase and sale of farmland.

Although futures contracts for the purchase and sale of real property, such as farmland, have heretofore not been traded, there have been a number of tradable products and systems that relate, in some way, to real property. For example, for many years Fannie Mae and Freddie Mac have purchased residential mortgages on the secondary market, pooled them, and sold them as “mortgage-backed securities” to investors on the open market. However, the securitization of mortgages in this manner does not create a market for the real property that is secured by the mortgages because, although the value of these securities is tied to the repayment of the loans secured by the mortgages, no real property is transferred from its owners to the holders of the securities.

A number of United States patents and patent applications also describe trading systems that related to real property. However, none of these systems actually creates a market for the underlying real property.

United States Publication No. 20060271388, titled “Derivative securities utilizing commercial real estate indices as underlying”, discloses a system of index-based property futures and property options contracts based on the National Council of Real Estate Investment Fiduciaries (NCREIF) Property Indices, which show performance returns for commercial real estate. This system is based upon real property, insofar as it the indices are based upon returns on real estate investments. However, like the mortgage based securities discussed above, there is never any delivery of the real property and the participants in this market are interested solely in the investment value of the securities and not in the purchase of the underlying real property assets.

United States Publication No. 20080275805, titled “Method for valuing forwards, futures and options on real estate”, discloses a system for creating a indices of local real estate values, measured based upon lease rates, and buying and selling derivative securities based upon these indices. The system of this publication is similar in many respects to the system disclosed in United States Publication No. 20060271388. In each system, the value of the security is based upon an index that relates to real property, in this case the value of leases for such property. However, like the system disclosed in United States Publication No. 20060271388 there is never any delivery of the real property and the participants in this market are interested solely in the investment value of the securities and not in the lease or purchase of the underlying real property assets.

Therefore, there is a need for a system for commoditizing farmland that will support a system for trading futures contracts for the purchase and sale of farmland, and for a system for trading futures contracts for the purchase and sale of farmland that allows owners and potential purchasers to hedge their risk, and that allows speculators and investors to participate in the trading of futures on these contracts without needing to actually buy or sell farmland.

### SUMMARY OF THE INVENTION

The present invention is a system for commoditizing farmland, a system for fulfilling futures contracts for the purchase and sale of farmland, and a system for settlement of farmland futures contracts.

The system for commoditizing farmland is a computerized system that includes a processor and a memory onto which at least one computer program product is stored. The computer program product includes software code that that inputs selected soil data for a tract of land, inputs property boundary line data defining a parcel or series of commonly owned parcels within the tract of land, overlays the soil data over a selected parcel or parcels, analyzes certain land quality measures based upon the overlay of the soil data with the boundary line data, classifies the parcel as “Prime Farmland”, “Tier 1 Farmland”, or “Tier 2 Farmland” based upon the result of the analysis of land quality measures, and assigns a size designation to the parcel or group of commonly owned parcels.

One of the key aspects of the commoditization system of the present invention is the overlay of the soil data with data identifying commonly owned parcels of land in order to classify these parcels. The system's analysis of land quality measures based upon the overlay of the soil data with the boundary line data involves a number of separate determinations. The system determines the percentage of the parcel or parcels of land that is “Prime Farmland”, “Farmland of Statewide Importance”, or “Farmland of Unique Importance”. The system determines the percentage of the parcel or parcels of land that is “Prime Farmland if drained”, “Prime Farmland if irrigated” or “Prime Farmland if irrigated and drained”. The system determines the percentage of the parcel or parcels of land that is water. The system determines the percentage of the parcel or parcels of land that falls under other farmland classifications. These farmland classifications are preferably the standard farmland classifications listed by the Natural Resources Conservation Service (NRCS) in Section 622.03 of its National Soil Survey Handbook.

The system also determines the percentage of the parcel or parcels having non-irrigated capability class ratings I, II, III, IV, V, VI and VII respectively. These capability class ratings are preferably the standard land capability classifications listed by the Natural Resources Conservation Service (NRCS) in Section 622.02 of its National Soil Survey Handbook.

Once all of the analyses of land quality measures are made, the system then assigns a land quality classification by classifying the parcel as “Prime Farmland”, “Tier 1 Farmland”, or “Tier 2 Farmland”. It is noted that parcels classified as “Prime Farmland” do not need to consist solely of land that would be classified as “Prime Farmland” by the National Soil Survey Handbook. Rather, as discussed below, the “Prime Farmland” classification means that a certain percentage of the parcel is “Prime Farmland” and that the parcel meets other predetermined land quality measures.

Another key aspect to the system for commoditizing farmland is the assignment of a size designation and acceptable parcel shape that conforms closely to the normal standards of the Public Land Survey System (PLSS). Such size should be a rectangular increment of equal to or less than, but being one half or one quarter of what is commonly known as a “quarter of a quarter”, which is one quarter of a one quarter section of a PLSS survey to the commonly traded futures contract. In the preferred system, the size designations assigned by the system are directly correlated to “Contract Grouping Designations” or “Designations” under futures contracts. These Designations are groupings of a particular range of parcels of land, referred to as contracts, for delivery. Each number of contracts within each Designation have a defined set of delivery variables unique to such Designation including, but not limited to, frontage requirements, boundary specifics, shape restrictions and size being determined by the actual number of contracts plus or minus delivery variances. Designation I has the smallest number of contracts that can be grouped together with shared requirements for delivery purposes, while Designation V has the largest number of contracts that can be grouped together with shared requirements for delivery purposes.

In some embodiments of the system, the system will section a parcel or parcels of land into a series of parcels based upon desired land quality classifications and/or size designations. For example, a certain parcel of land may qualify as Tier I farmland having a size designation IV if the entire parcel is considered. However, based on market pricing, it may be more advantageous to section the parcel so that it qualifies as one parcel of Prime Farmland having a size designation III and one parcel of Tier I farmland having a size designation I. Therefore, some embodiments of the system will automatically make these calculations and present land quality and size designation options for the parcel as a whole and as two or more sections.

The system for fulfilling futures contracts for the purchase and sale of farmland is a computerized system that includes a processor and a memory onto which at least one computer program product is stored. The computer program product includes the software code for commoditizing farmland, as described in detail above, to verify that farmland tendered for delivery complies with the terms of each futures contract and to approve the farmland tendered for delivery. The computer program product also includes software code for pairing buyers and sellers for delivery under the futures contracts.

In the preferred system, all people who have agreed to sell farmland under futures contracts (hereafter referred to as “shorts”) and intend to make physical deliver must provide the system with property information to identify the property to be delivered, or a “due bill” promising to deliver the required property at a later date, before the system pairs buyers (hereafter referred to as “longs”) with shorts. The “due bill” for any specific Prime Farmland Contract will be specifically known as a “Prime Farmland Due Bill” (PFDB). The ‘due bill” for any specific Tier 1 Farmland Contract will be specifically known as a “Tier 1 Farmland Due Bill” (T1-FDB), The “due bill” for any Tier 2 Farmland Contract will be specifically known as a “Tier 2 Farmland Due Bill” (T2-FDB). Delivery map zone particulars will further mandate each due bill being more explicitly defined as per a specific delivery region.

Regardless of whether a property description is provided prior to the system pairing off longs with shorts or in connection with the delivery under a due bill, the software code for commoditizing farmland will use the property description to assign land quality and size designations to the farmland tendered for delivery and compare this with the short's contract requirements to ensure that the tendered farmland complies with the terms of contract. In the preferred embodiment, the system inputs delivery configuration requirements for the size designations of said futures contracts and inputs delivery zone requirements and verifies that the parcel tendered for delivery meets both the delivery configuration requirements and delivery zone requirements.

In the preferred system, the pairing off of shorts and longs is a two-tiered process. The system first pairs off the largest contractually permissible short positions that have land approved for delivery. In this process, the system first attempts to pair shorts having property of the largest size, i.e. contract parcels of “Designation V”, with a complete match to longs holding contracts for an equal or greater number of contract parcels. The process then works down incrementally through each respective designation ultimately getting to a single contract parcel delivery from “Designation I”. After the system pairs off all short positions that have land approved for delivery, the system pairs off the largest contractually permissible short positions that provided due bills for delivery. The system follows the same process with due bills as it did with land approved for delivery. The system first attempts to pair shorts having due bills requiring property of the largest size with a complete match to longs holding contracts for an equal or greater number of contract parcels. The process then works down through all the designations to a single contract delivery from “Designation I”.

In each pairing process, the match selection within any specific number of contracts is preferably made using a random selection process with all eligible increments. In the preferred embodiment, the contracts designated by the short, preferably in one to sixty four, one to thirty two, or one to sixteen contract parcel increments, can only be matched with a long position of an equal or greater number of contracts and shorts having multiple deliveries of the exact same number of blocks may prioritize their preference for any delivery matches. However, it is preferred that a long position may be satisfied by multiple short deliveries of varying size designations.

The system for commoditizing farmland and the system for fulfilling futures contracts for the purchase and sale of farmland provide the basis for a series of unique farmland futures. Farmland characteristics will allow structuring of different quality farmland contracts and farmland contracts of specific regions. Contracts may be traded through existing exchanges, or through a newly created exchange. Regardless of how the contracts are traded, the contract settlement system of the present invention is preferably used to settle contracts. The contract settlement system includes all of the features of the contract fulfillment system, but also includes the ability to settle contracts without an actual physical delivery of land under the contract.

The contract settlement system is a computerized system that includes a processor and a memory onto which at least one computer program product is stored. The computer program product includes the software code for commoditizing farmland, as described in detail above, to verify that farmland tendered for delivery complies with the terms of each futures contract and to approve the farmland tendered for delivery, and the software code for pairing buyers and sellers for delivery under the futures contracts. The computer program product also includes a settlement program that includes software code for creating and managing trading accounts and for closing contracts.

The preferred settlement program works with the software for pairing buyers and sellers such that a contract is automatically closed through a cash settlement when a pair-off match does not occur for either a physical delivery or a due bill delivery. The preferred settlement program also includes software for closing contracts where a default has occurred, due to the failure of a short to tender either approved land or a due bill, which preferably results in performance margin forfeiture within the contract parameters satisfying contract fulfillment requirements. The preferred settlement program also includes the ability to close contracts through the buy-out of a short's due bill obligation and/or through the long's termination of the due bill after a predetermined period of time. Finally, the preferred settlement program includes the ability to extend due bill obligations by transferring extension fees from a short's account to a long's account.

Therefore, it is an aspect of the invention to provide a system for commoditizing farmland that will support a system for trading futures contracts for the purchase and sale of farmland.

It is a further aspect of the invention to provide a system for trading futures contracts for the purchase and sale of farmland that allows owners, investors, the housing and timber industries, commercial developers, potential purchasers and other commercial interests to hedge their risk.

It is a further aspect of the invention to provide a system for trading futures contracts for the purchase and sale of farmland that includes a due bill system to allow trading of futures contract without needing to actually own farmland.

It is a further aspect of the invention to provide a system for commoditizing farmland that analyzes and classifies farmland based upon land quality and size characteristics unique to an individual farmland contract.

It is a further aspect of the invention to provide a system for fulfilling futures contracts for the purchase and sale of farmland that ensures that land tendered for delivery meets land quality and size requirements and all other specifications of a futures contract.

It is a further aspect of the invention to provide a system for fulfilling futures contracts for the purchase and sale of farmland that randomly pairs buyers with sellers for delivery of farmland.

It is a further aspect of the invention to provide a system that works downward, starting with shorts from the designation V maximum number of contracts to a single contact attempting a physical delivery then next to those attempting a due bill delivery.

It is a further aspect of the invention to provide a system that further protects the seller of farmland from partial sales yet can offer protection to large long holdings from being delivered an excessive amount of small deliveries.

It is a further aspect of the invention to provide a settlement system that integrates the functions of a settlement agent with the system for fulfilling futures contracts for the purchase and sale of farmland.

It is a further aspect of the invention to provide a settlement system having a delivery process that allows contracts to be cash settled with no delivery match, to be settled by a delivery match for a mandatory physical delivery, and a delivery match resulting in a due bill delivery.

It is a further aspect of the invention to provide a trading system in which a due bill delivery allows an option to be purchased by the issuer to buy out of the obligation or to extend such obligation for period of time and further allows the holder of such due bill to at times exercise a termination option.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a screen shot of a prior art farmland classification map produced by the NRCS Web Soil Survey program.

FIG. 2 is a screen shot of a prior art farmland classification summary for the map of FIG. 1.

FIG. 3 is a screen shot of a boundary line overlaid by a farmland classification map by the system for commoditizing farmland.

FIG. 4 is a screen shot of a boundary line and a series of dividing lines defining a series of internal parcels overlaid by a farmland classification map by the one embodiment of the system for commoditizing farmland.

### DETAILED DESCRIPTION OF THE INVENTION

The systems of the present invention were developed in order to create tradable farmland futures and options contracts that allows current and prospective land owners along with other commercial interests, investors and others to hedge the risk of price fluctuations in the market for farmland and to provide a safer haven for land speculation while such speculators provide additional liquidity into the market. For purposes of the present invention, farmland is intended to broadly encompass cropland, rangeland, grazing land, pasture land, native and naturalized pasture land, hay land, forest land, other agricultural used land, and land, other than urban land, that may be adapted for agricultural use.

The preferred futures contracts trade in contract parcels, sometimes referred to simply as “contracts”, which are of a predetermined size. The preferred futures contracts use a hypothetical “block”, which is a percentage of a one square mile township section for aiding in sectional delivery acceptance. Using specifically sized rectangular blocks; a section can be reconstructed to suit a delivery of up to six hundred and forty acres, such being a perfect township section. The futures contract uses up to five contract grouping designations with specifications unique to each, which encompass different size ranges starting with a single contract parcel block in designation “I” and extending up to the maximum number of contracts or contiguous contract parcels in designation “V”. The contract can also accept non-sectional acreage and irregular shaped properties for delivery meeting certain contract specifications.

The standardization of the contracts were developed by wrapping a specifically tailored selection of land quality specifications using NRCS Land Capability Classifications I through VIII and NRCS Farmland Classifications along with contractual specifications and requirements that allows the creation of a standardized, tradable, homogeneous contract. It is preferred that six discrete contracts be issued based upon selected land quality classifications; a “Prime Farmland” contract, a “Tier I Farmland” contract and a “Tier II Farmland” contract. Each contract will preferably trade with two specific delivery zones know as “Eastern Heartland” and “Western Heartland”, although other geographic delivery zones may be utilized to achieve similar results.

The futures contracts include a delivery mechanism that incorporates a due bill process with such instrument having embedded options to both the issuer and holder. Such due bill may have a life of up to 12 months in duration. The due bill provides necessary liquidity in alleviating prohibitive time constraints towards identifying and procuring qualifying land. Without the due bill, prices for contracts could be more easily manipulated prior to contract expiration, which could comprise the integrity of the contracts.

The first component necessary for the implementation of the farmland futures contracts was the development of a system for commoditizing farmland. The inventor of the present invention researched different types of land in an attempt to find a way to create something that could be made into a homogeneous product that could be standardized into a contract that could be traded on an exchange. This research involved discussion with soil scientists, GIS experts, agronomy school professors along with government publication research and library research to better understand agronomy and issues pertaining to farmland and soils in order to find a way to not just allow index based trading, but to have a standardized physical delivery. Index traded contracts exist because it is understood that physical delivery is just not feasible and, prior to the development of the present invention, it was assumed that contracts involving real property could only be index based. What the inventor discovered was that farmland had some generic features that were public and maintained by the National Resources Conservation Service (NRCS), part of the USDA. After countless attempts during the course of a year, the inventor was able to develop a system for commoditizing farmland that would allow for the creation of futures contract having an actual delivery component.

The system uses selected data from the “Land Capability Classifications” and “Farmland Classifications” of the USDA Natural Resources Conservation Service to classify land quality, which resulted in the creation of three different core contracts; Tier 1 Farmland, Tier 2 Farmland, and Prime Farmland. Each being categorized under a different set classification requirements with quality characteristics appealing to different hedging interests. All allowing for more closely correlated hedges by reducing basis risk while providing increased liquidity through spread transactions. Basis risk being further reduced with establishment of multiple delivery zones for each Tier 1, Tier 2 and Prime Farmland contract allowing for even more robust, strongly correlated trading hedges.

In the United States, soil data is produced by the National Cooperative Soil Survey and disseminated publicly by the USDA Natural Resources Conservation Service (NRCS). NRCS currently has soil maps and data available online for more than ninety-five percent of the nation's counties and anticipates having one hundred percent in the near future. The NRCS has an on-line soil data mapping tool, called the “Web Soil Survey”, which identifies capabilities and characteristics for soils and land and for areas within a tract of land. The Web Soil Survey uses the capability classifications listed by the NRCS in Section 622.02 of its National Soil Survey Handbook, which include, but are not limited to, classifications I-VIII. The Web Soil Survey also classifies land and areas within a tract of land using the farmland classifications listed by the NRCS in Section 622.03 of its National Soil Survey Handbook which include, but are not limited to, “Not prime farmland”, “All areas are prime farmland”, “Prime farmland if’ certain work is done to the land, “Farmland of statewide importance”, “Farmland of local importance” and “Farmland of unique importance”.

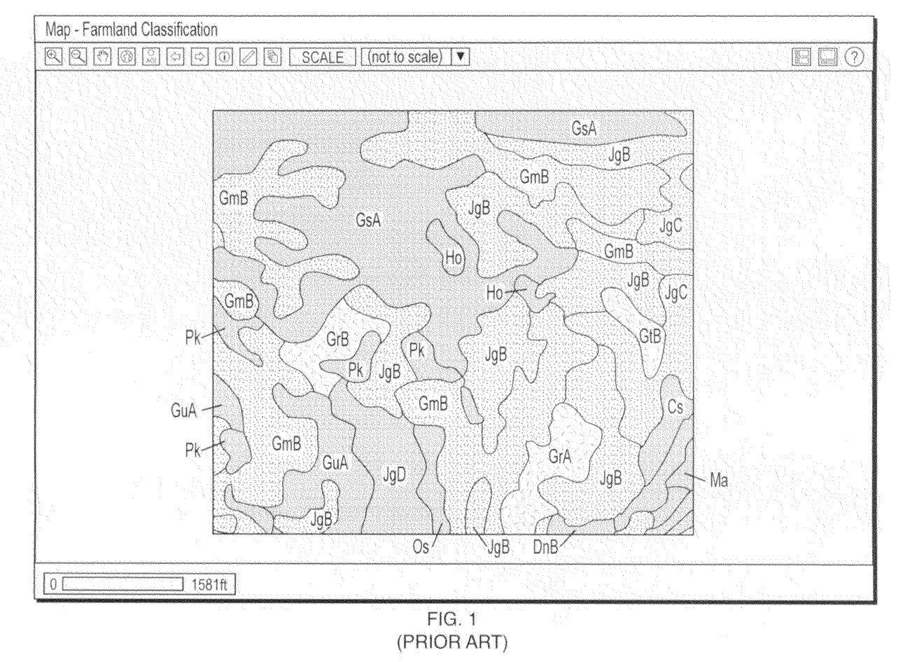

FIG. 1 shows a map of an area of land created by the Web Soil Survey program that identifies portions of land having certain quality characteristics. The area of land is identified in the program as an “area of interest” or “AOI”, which is chosen by the user. The user may only manually draw this onto the map and there is currently no way to define an area of interest in terms of specific geographic coordinates.

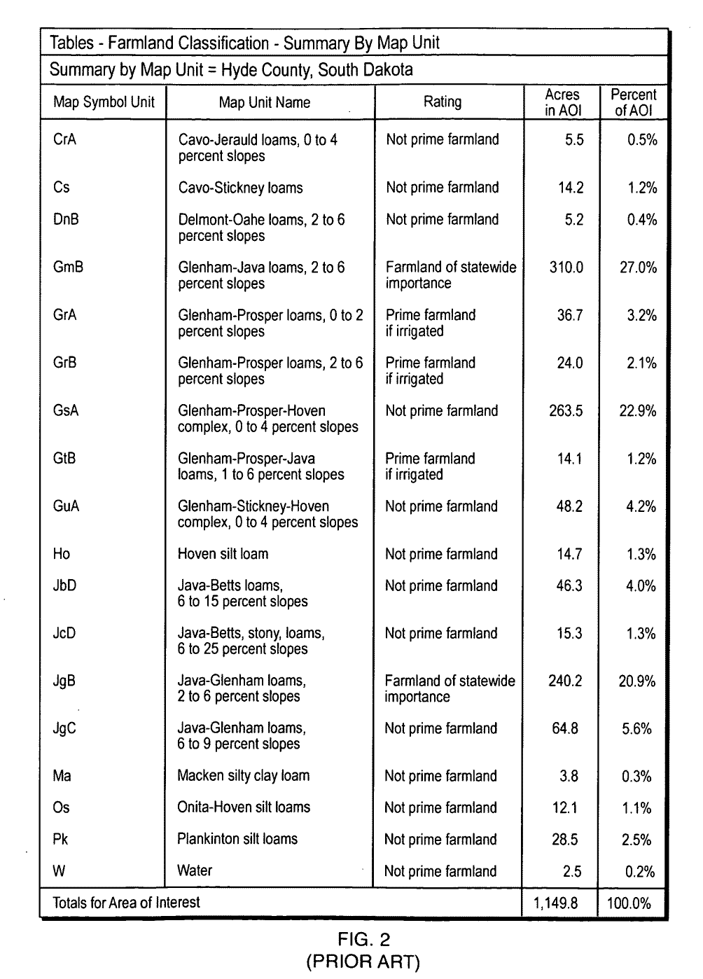

FIG. 2 shows a table of values for the area of interest on the map of FIG. 1, which shows the land classification ratings attributable to the various quality codes, the number of acres in the area of interest having these codes, and the percentage of the overall area of interest that is covered by each code. It is noted that the Web Soil Survey also classifies land in non-irrigated capability class ratings I, II, III, IV, V, VI and VII in a manner similar to the classification based upon the farmland classification map.

The NRCS Web Soil Survey does not include any way to determine how land is divided into parcels, who owns the parcels, or whether a particular parcel or series of parcels of land meets any particular overall characteristics. Accordingly, one of the key aspects of the commoditization system of the present invention is the application of the soil data to data identifying commonly owned parcels of land in order to classify these parcels.

The preferred system for commoditizing farmland utilizes data from the NRCS Web Soil Survey to classify specific parcels of land. The system requires inputs for a particular tract of land within a specified delivery zone that includes boundary data defining the parcel or series of commonly owned parcels making up the total tract of land. Such mapping system may utilize the capabilities of the NRCS “Web Soil Survey”, or may merely import the Web Soil Survey data.

The computer program product includes software that allows inputs of property boundary line data defining a parcel or series of commonly owned parcels, overlays the soil data over the selected parcel or parcels, determines NRCS ratings based upon the overlay of the soil data within the boundary line data, and classifies the parcel. This classification preferably follows the Land Capability Classes specified under NRCS National Soil Survey Handbook and Agricultural Handbook, or Farmland Classifications of the NRCS National Soil Survey Handbook. Selected classifications only will be used to determine qualification for the specific parcel or parcels in meeting the particular requirements of any farmland futures contracts.

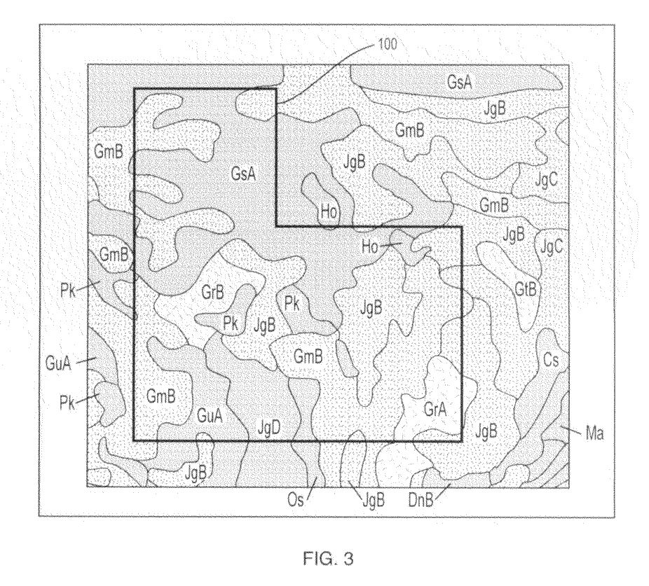

FIG. 3 shows the map of FIG. 1 overlaid over a boundary line 100 using the system for commoditizing farmland. As shown in FIG. 3, the boundary line 100 is irregularly shaped and is based upon specific geographic coordinates that define a commonly owned parcel. The system for commoditizing farmland uses this boundary line 100 to define the area of interest and then performs the same types of calculations as the Web Soil Survey to identify the various percentages of the parcel that fall within the selected land quality measures. As discussed above, the system's analysis of land quality measures based upon the overlay of the soil data with the boundary line data involves a number of separate determinations. The system determines the percentage of the parcel or parcels of land that is “Prime Farmland”, “Farmland of Statewide Importance”, or “Farmland of Unique Importance”. The system determines the percentage of the parcel or parcels of land that is “Prime Farmland if drained”, “Prime Farmland if irrigated” or “Prime Farmland if irrigated and drained”. The system determines the percentage of the parcel or parcels of land that is water. The system determines the percentage of the parcel or parcels of land that falls under other farmland classifications. The system determines the percentage of the parcel or parcels having non-irrigated capability class ratings I, II, III, IV, V, VI, and VII respectively.

The system then performs the additional step of analyzing the percentages and classifying the parcel as “Prime Farmland”, “Tier 1 Farmland”, or “Tier 2 Farmland” based upon the result of the analysis of land quality measures. This land quality classification is preferably performed as follows.

The preferred system classifies a parcel or parcels of land as “Prime Farmland” if the following conditions are met. At least an established minimum percentage of land is “Prime Farmland”, “Farmland of Statewide Importance”, or “Farmland of Unique Importance”; no more than an established maximum percentage of the total land delivered may be designated as “Not Prime Farmland” or other “Prime Farmland” classifications; no more than a maximum percentage of the land is water; and no more than a total percentage may include “Not Prime Farmland” and “water” and the balance of the land is designated “Prime Farmland if drained”, “Prime Farmland if irrigated” or “Prime Farmland if irrigated and drained” and may further include other farmland classifications if determined beneficial to the contract.

The preferred system classifies a parcel or parcels of land as “Tier I Farmland” if at least if the following conditions are met. At least an established minimum of the land delivered has a non-irrigated capability class rating of I, II or III. The remaining land may include non-irrigated rated land capability classifications IV, V, and VI, with the limiting condition that no more than an established maximum percentage of the land may be of Classification VI. Water may in total account for an established maximum percentage of the property. However, the total of land capability class VI and water may not, in total, account for more than an established maximum percentage.

The preferred system classifies a parcel or parcels of land as “Tier II Farmland” if the following conditions are met. At least an established minimum of the land delivered has a non-irrigated capability class rating of VI or higher. The remaining land may include land of capability classification VII, with the limiting condition that no more than an established maximum percentage of the land may be of Classification VII. Water may in total account for an established maximum percentage of the property. However, the total of land capability class VII and water may not, in total, account for more than an established maximum percentage.

The system also measures the size of the parcel defined by the boundary line 100 and assigns a size designation to the parcel. In order for farmland to be economically viable to its purchaser, it ideally should be of a size that allows the purchaser to profitably farm. Sufficiency of size may vary depending upon the purchaser and their individual needs. However, it is also important to consider a size contract that will allow a range of acreage sizes to be eligible for delivery with limiting parcel sizes being left out, further there will be small parcels of land that meet delivery criteria and are important to include in the contract. Parcel sizes of a quarter of quarter section (40 acres), one half of the quarter of a quarter (20 acres) and one quarter of the quarter of a quarter (10 acres) adequately address sizing issues.

In the preferred system, each the size designation corresponds to a “Contract Grouping Designation” for a specific contract, each of which has a set of delivery requirements unique to such designation. Designation I, II, III, IV and V will specify a minimum and maximum number of contracts deliverable per each designation and further have respective “building block” delivery guidelines for acceptable configurations within a township section.

In the preferred system, the contract size designations may act as representative rectangular parcels for bundling, or grouping purposes, referred to herein as “blocks”, or “building blocks” each of which represents a percentage of a perfect one square mile township section. The use of blocks uniquely acts to provide a requirement for acceptable delivery configurations within a township section by requiring that a certain number of blocks be located in each ¼ or ½ section. For example, in the preferred system, all rectangle shaped Designation 2 blocks must be within a single ¼ of a section, or sixteen blocks forming an approximate 1,320′ by 5,280′ deliverable piece, while all rectangle shaped Designation 3 groupings must be within a single ½ of a section, with either a complete ¼ section or 16 building blocks forming an approximate 1,320′ by 5,280′ complete deliverable piece. Each designation requires that the parcel is not land-locked from road frontage, meets certain minimum road frontage requirements and overall boundary requirements. The system also has determined a methodology that accommodates non-perfectly sized sections and subsections of those; further such a system can accommodate irregular shaped parcels and parcels not of the Township and Section type PLSS.

In the preferred system, a parcel is assigned a size designation of “I” if it has one to eight contiguous blocks that may be grouped together to form a rectangle. A parcel is assigned a size designation of “II” if it has nine to sixteen contiguous blocks that may be grouped together to form a rectangle. A parcel is assigned a size designation of “III” if it has seventeen to thirty-two contiguous blocks that may be grouped together to form a rectangle. A parcel is assigned a size designation of “IV” if it has thirty-three to forty-eight contiguous blocks that may be grouped together to form a rectangle. Finally, a parcel is assigned a size designation of “V” if it has forty-nine to sixty-four contiguous blocks that may be grouped together to form a rectangle. However, it is noted that these size designations are merely the preferred designations and the system may utilize more or fewer such designations and/or include different ranges of blocks for each designation.

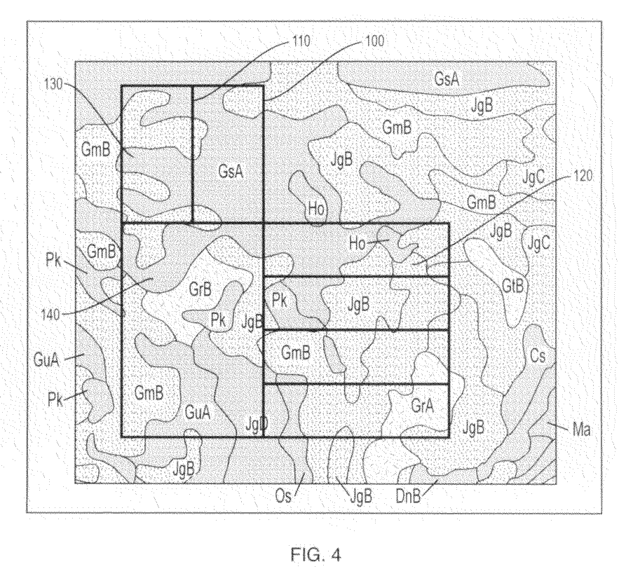

In some embodiments of the system, the system will section a parcel or parcels of land into a series of parcels based upon desired land quality classifications and/or size designations. As shown in FIG. 4, some embodiments of the system have the capability of inserting internal dividing lines 110 defining a series of internal parcels 120, 130, 140 within the overall parcel. As shown in FIG. 4, the internal parcels 120, 130, 140 may have different shapes and sizes. However, the system will only section the overall parcel such that the internal parcels are multiples of a standard block and such that the internal parcel meets all internal frontage requirements. This feature is advantageous in cases where the parcel includes land of multiple classification and the owner wishes to maximize the amount of money to be obtained by the land. For example, a certain parcel of land may quality as Tier I farmland having a size designation IV if the entire parcel is considered. However, it may be more advantageous to section the parcel so that it qualifies as one parcel of Prime Farmland having a size designation III and one parcel of Tier I farmland having a size designation I. These embodiments of the system allow this to be accomplished automatically.

The system for commoditizing farmland forms the basis for a homogenous trading system for farmland that utilizes selected non biased government data, overlays such data on a system, categorizes such selected data into acceptability buckets, and imposes a set of specifications and requirements that allows standardization and the ability to create a generic futures contract. One unique aspect of this trading system is a system for fulfilling futures contracts for the purchase and sale of farmland in which farmland may be tendered for physical delivery.

The system for fulfilling futures contracts for the purchase and sale of farmland is a computerized system that includes a processor and a memory onto which at least one computer program product is stored. The computer program product includes the software code for commoditizing farmland, as described in detail above, to verify that farmland tendered for delivery complies with the terms of each futures contract and to approve the farmland tendered for delivery. In order to approve the farmland tendered for delivery, the system monitors for compliance on a number of contractually specific determinants being met to qualify delivery status. The system must know the particular details and specifics of each unique futures contract. The system must know the proposed size of acreage delivered; i.e. whether the intended delivery size is within the variance range for the number of contracts being delivered. The system must know if the percentages of the classifications meet the eligibility and minimum requirements of each contract; i.e. does the land meet the delivery specifications for a “Prime Farmland Contract”, a “Tier 1 Farmland Contract” or a “Tier 2 Farmland Contract”.

In the preferred fulfillment system, the system must also know the geographic criteria for each contract; i.e. whether the parcel intended for delivery conforms to the specific map zone of the contract being delivered into. Each Futures contracts will further have a unique delivery zone or zones creating zone specific contracts. The system will be able to determine partial delivery eligibility to a “Tier 1 Farmland Contract”, a “Tier 2 Farmland Contract” and a “Prime Farmland Contract” and for any zone specifics for these contracts based upon the result of the analysis of land quality measures. Preferably, but not limited to, Tier 1, Tier 2 and Prime Farmland contracts will each trade as an “Eastern Heartland” and a “Western Heartland” contract, being determined by two distinct delivery map zones. The total number of farmland futures contracts being six. Zone maps may be added or altered and contracts may be added, removed or altered to conform to demands.

Once all of the analyses are made, a parcel or parcels can be designated as good for delivery for a specific contract. For example a parcel may be designated as good delivery for a “Prime Farmland (Eastern Heartland) Contract” or, based on location, a “Prime Farmland (Western Heartland) Contract”. Similarly a contact may be designated as good delivery for “Tier 1 Farmland (Eastern Heartland) Contract” or, based on location, a “Tier 1 Farmland (Western Heartland) Contract” Finally a contract may be designated as good delivery for “Tier 2 Farmland (Eastern Heartland)” or, based on location, a “Tier 2 Farmland (Western Heartland)” Each individual delivery must also conform to all other specifications of the contract that together will allow the standardization or commoditization of farmland.

Unique to this invention and significant to the creation of farmland futures contracts is the use of a “due bill” in the contract fulfillment process. The term due bill is a generic term that has been used commonly in the commodity and financial markets. Created for these contracts are three unique due bill type instruments specific to Tier 1 Farmland Futures Contracts, Tier 2 Farmland Futures Contracts and Prime Farmland Futures Contracts. The due bills will specifically be called a Tier 1 Farmland Due Bill, a Tier 2 Farmland Due Bill and a Prime Farmland Due Bill. Each due bill will further be designated as an Eastern or Western Heartland due bill. Additional due bills will be created as new delivery zones are developed.

The due bill acts to stabilize the contact, maintains pricing fairness, provides liquidity, and safeguards the overall integrity of the delivery process. Futures contracts are dependent on adequate supply of what meets the deliverable specifications to flourish. Inadequate supply or shortages can lead to manipulation or squeezes. This being evident from occurrences in financial futures contracts where longs purchasing most of the cheapest to deliver have forced contracts to price off other securities.

The farmland due bills uniquely allow sellers of contracts to maintain positions past expiration when they have not yet had land approved for delivery. Further, these farmland due bills allow sellers to maintain positions into the physical delivery process when they do not even own land to deliver. It provides time for the seller to acquire land and yet still sell the contract when it is trading at a price the seller believes to be too high. The farmland due bill with the purchase of quarterly extension options by the issuer may have an established maximum life of twelve months, where at the end, if not prior, physical delivery must occur.

In the preferred system, the due bills may have quarterly options where the issuer may buy out the remaining due bill obligation. Further the holder of the obligation has at specific times an option and right to terminate any due bill outstanding and not be required to wait past a certain date for delivery. The system will further maintain at least one computer program to monitor due bills outstanding and dates. In addition, all aspects of a physical delivery where processor and memory capabilities are used may be used for due bills that will be fulfilled by physical delivery.

In the preferred system, the maximum number of contracts that may be grouped together in the highest size designation will be of number that equals a total of six hundred and forty acres; as such size is equal to the size of a perfect Township section. When a contract parcel is defined as a ten-acre block, the maximum number of contracts that may be grouped together is preferably sixty-four contracts.

The preferred fulfillment system pairs off of shorts and longs using a two-tiered process. The system first pairs off the largest qualifying short positions that have land approved for delivery. In the preferred system, short contracts attempting delivery will be allocated to a Contract Grouping Designation. Contracts grouped by a short position of one to a maximum number of contracts not exceeding eight will be of “Designation I” and be required to meet all requirements of such designation. Contracts grouped by a short position of the previous maximum contracts plus one to a maximum number of contracts not exceeding sixteen will be of “Designation II” and be required to meet all requirements of such designation. Contracts grouped by a short position of the previous maximum contracts plus one to a maximum number of contracts not exceeding thirty-two will be of “Designation III” and be required to meet all requirements of such designation. Contracts grouped by a short position of the previous maximum plus one to a maximum number of contracts not exceeding forty-eight will be of “Designation IV” and be required to meet all requirements of such designation. Contracts grouped by a short position of the previous maximum plus one to a maximum number of contracts not exceeding sixty-four 64 will be of “Designation V” and be required to meet all requirements of such designation.

In the preferred system the maximum number of contracts that may be grouped together into the highest designation will equal the total of six hundred and forty acres, with such size being that of a perfect Township section. In the preferred system, the number of contracts that may be grouped together into the highest designation will be a minimum of sixteen contracts and a maximum of sixty-four contracts.

In the preferred system, each Contract Grouping Designation will offer a set of delivery requirements unique to such designation. Designation I, II, III, N and V will further have respective “building block” delivery guidelines for acceptable configurations in a section. Parcels delivered for contracts under all designations will be contiguous. Specifications will be established for acceptance of non-sectional deliveries and irregular shaped parcels. Each designation will further specify its respective frontage and boundary requirements along with other requirements.

After the system pairs off the short positions that have land approved for delivery, the system pairs off the short positions that provided due bills for delivery. The system follows the same process with due bills as it did with land approved for delivery. The system first attempts to pair shorts having due bills requiring property of the largest size with a complete match to longs holding a contracts for an equal or greater number of blocks. The process then works down through all the designations to a single contract delivery from “Designation I”.

In each pairing process, the match selection within any specific number of contacts is preferably made using a random selection process with all eligible increments. In the preferred embodiment, the contracts designated by the short, preferably in one to sixty four, one to thirty two and one to sixteen contract parcel increments, can only be matched with a long position of an equal or greater number of contracts and shorts having multiple deliveries of the exact same number of blocks may prioritize their preference for any delivery matches. However, it is preferred that a long position may be satisfied by multiple short deliveries of varying size designations.

As noted above, the system for commoditizing farmland and the system for fulfilling futures contracts for the purchase and sale of farmland provide the basis for a series of unique farmland futures. Farmland characteristics will allow structuring of different quality farmland contracts and farmland contracts for specific regions. Contracts may be traded through existing exchanges, or through a newly created exchange. The exchange will preferably function in a manner similar to existing exchanges. It will be responsible for providing a forum for the trading of contracts, the monitoring of market equilibrium, calling attention to signals of potential stress, and making contractual changes to deter and prevent instability protecting the integrity of the exchange. The exchange will preferably have the ability to adjust due bill costs, extension fees and buy out fees, allowing more control in limiting due bill issuance through increased or decreased costs. The exchange will preferably also have the ability to limit or curtail the number of due bills issued, allowing even greater control of due bill issuance if necessary in periods of potential stress. The exchange will preferably also have the ability to expand delivery map zones, allowing control of expanding the delivery territory, which would increase deliverable quantity and introduce areas priced differently than the current zone. The exchange will preferably also have the ability to change or modify delivery classification requirements, allowing still greater control if needed in periods of potential stress.

In the preferred embodiment of the invention, contracts are settled using the contract settlement system of the present invention. The contract settlement system is a computerized system that includes a processor and a memory onto which at least one computer program product is stored. The computer program product includes the software code for commoditizing farmland, as described in detail above, to verify that farmland tendered for delivery complies with the terms of each futures contract and to approve the farmland tendered for delivery, and the software code for pairing buyers and sellers for delivery under the futures contracts. The computer program product also includes a settlement program that includes software code for creating and managing trading accounts and for closing contracts regardless of whether an actual physical delivery of land has taken place, or will take place, under the contract.

The preferred settlement program works with the software for pairing buyers and sellers such that a contract is automatically closed through a cash settlement when a pair-off match does not occur for either a physical delivery or a due bill delivery. It is envisioned that a large percentage of futures contracts traded will not be matched for delivery. Accordingly, the system includes software for identifying those buyers and sellers who are not matched and adjusting the balances of the trading accounts for each based upon the market price of the contract on the date of closing.

The preferred settlement program also includes software for closing contracts where a default has occurred. Default may occur due to the failure of a short to tender either approved land or a due bill, the failure of the long to accept delivery of land, or other circumstances. When this happens, the settlement program will cause a performance margin within the contract parameters satisfying contract fulfillment requirements to be forfeited.

The preferred settlement program also includes software for closing contracts through the buy-out of a short's due bill obligation and/or through the long's termination of the due bill after a predetermined period of time. In instances where a short cannot find suitable farmland to tender for delivery, the short may exercise a buyout of its position. In such instances, the settlement program will adjust the balances of the trading accounts for the short and the long according. Similarly, if a short cannot tender land for delivery and wishes to extend the maturity of his due bill, the long may elect to terminate the due bill at specified times when a “termination window” is open and accept a cash settlement, in which case settlement program will adjusting the balances of the trading accounts for the long and short based upon the market price of the contract on the date of closing.

Finally, the preferred settlement program includes the ability to extend due bill obligations by transferring extension fees from a short's account to a long's account and requiring the short to pay these fees into their account to effect such transfer. Provided the extension fee is paid, and the long has not previously exercised their right to terminate, the preferred settlement system will automatically process this transaction.

The farmland futures contracts that are enabled by the system for commoditizing farmland and the system for fulfilling farmland futures contracts are readily adapted for trading in a number of different ways. For example, these contracts may form the basis for option trading, or may take the place of the commodity pools used in connection with the systems described in U.S. Pat. Nos. 7,283,978, or 7,319,984. Accordingly, the trading system of the present invention should not be seen as being limited to the trading of the particular futures contracts described herein but, rather, should be seen as broadly enabling trading of a wide range of derivatives that use commoditized farmland as their basis.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A system for commoditizing farmland comprising:
a processor; and
a memory onto which a computer program product for commoditizing farmland is stored;
wherein said computer program product for commoditizing farmland comprises;
software means for inputting selected soil data for a tract of land;
software means for inputting property boundary line data defining at least one parcel within said tract of land;
software means for overlaying said soil data over at least one of said at least one parcel of land;
software means for analyzing land quality measures based upon said overlay of said soil data over said at least one parcel of land;
software means for classifying said at least one parcel of land based upon a result of said analysis of land quality measures; and
software means for assigning a size designation to said at least one parcel of land.

2. The system for commoditizing farmland as claimed in claim 1 wherein said software means for inputting selected soil data for a tract of land comprises software means for imputing land quality codes for said tract of land and land classification ratings attributable to said land quality codes.

3. The system for commoditizing farmland as claimed in claim 1 wherein said software means for inputting property boundary line data defining at least one parcel within said tract of land comprises software means for defining an area of interest representing at least one commonly owned parcel of land.

4. The system for commoditizing farmland as claimed in claim 3 further comprising means for sectioning said at least one commonly owned parcels of land into at least two parcels of land;
wherein said software means for overlaying said soil data over at least one of said at least one parcel comprises software means for overlaying said soil data over each of said at least two parcels of land;
wherein said software means for analyzing land quality measures based upon said overlay of said soil data over said at least one parcel comprises software means for analyzing land quality measures for each of said at least two parcels of land based upon said overlay of said soil data;
wherein said software means for classifying said at least one parcel of land based upon a result of said analysis of land quality measures comprises software means for classifying each of said at least two parcels of land based upon a result of said analysis of land quality measures; and
wherein said software means for assigning a size designation to said at least one parcel of land comprises software means for assigning a size designation to each of said at least two parcels of land.

5. The system for commoditizing farmland as claimed in claim 1 wherein said software means for analyzing land quality measures based upon said overlay of said soil data over said at least one parcel comprises:
means for determining what percentage of said at least one parcel of land is prime farmland, farmland of Statewide Importance and farmland of unique importance;
means for determining what percentage of said at least one parcel of land is prime farmland if drained, prime Farmland if irrigated and prime farmland if irrigated and drained;
means for determining what percentage of said at least one parcel of land is water;
means for determining what percentage of said at least one parcel of land falls under other prime farmland classifications; and
means for determining what percentage of said at least one parcel of land have non-irrigated capability class ratings I, II, III, IV, V, VI and VII.

6. The system for commoditizing farmland as claimed in claim 1 wherein said software means for classifying said at least one parcel of land based upon a result of said analysis of land quality measures comprises means for classifying said at least one parcel of land as one of prime farmland, tier one farmland and tier two farmland based upon said result of said analysis of land quality measures.

7. The system for commoditizing farmland as claimed in claim 1 wherein said
software means for assigning a size designation to said at least one parcel of land comprises;
means for dividing said parcel of land into a plurality of rectangular parcels of a predetermined substantially equal size ;
means for counting a number of said plurality of rectangular parcels within said at least one parcel of land; and
means for comparing said number of said plurality of rectangular parcels within said at least one parcel of land with a number required for a particular size designation.

8. The system for commoditizing farmland as claimed in claim 7 wherein said software means for assigning a size designation to said at least one parcel of land further comprises means for determining whether said at least one parcel of land meets a predetermined minimum road frontage requirement for said particular size designation.

9. A system for fulfilling farmland futures contracts comprising:
a processor; and
a memory onto which is stored at least one computer program product for commoditizing farmland, a computer program product for approving farmland tendered for delivery, and a computer program product for pairing buyers and sellers for delivery under said farmland futures contracts;
wherein said computer program product for commoditizing farmland comprises;
software means for inputting selected soil data for a tract of land tendered for delivery;
software means for inputting property boundary line data defining at least one parcel within said tract of land;
software means for overlaying said soil data over at least one of said at least one parcel of land;
software means for analyzing land quality measures based upon said overlay of said soil data over said at least one parcel of land;
software means for classifying said at least one parcel of land based upon a result of said analysis of land quality measures; and
software means for assigning a size designation to said at least one parcel of land;
wherein said computer program product for approving farmland tendered for delivery comprises;
software means for imputing land quality and size designation requirements of said futures contracts; and
software means for determining whether said at least one parcel of land tendered for delivery meets said land quality and size designation requirements of said futures contracts; and
wherein said computer program product for pairing buyers and sellers for delivery under said farmland futures contracts comprises;
software means for imputing data corresponding to due bills tendered by sellers;
software means for pairing sellers having approved farmland tendered for delivery with buyers; and
software means for pairing sellers who have tendered due bills with buyers.

10. The system for fulfilling farmland futures contracts as claimed in claim 9 wherein said means for imputing data corresponding to sellers who have tendered due bills of said computer program product for pairing buyers and sellers for delivery under said farmland futures contracts comprises means for imputing land quality and size designation data for said due bills.

11. The system for fulfilling farmland futures contracts as claimed in claim 9 wherein said computer program product for pairing buyers and sellers for delivery under said farmland futures contracts first pairs sellers having approved farmland tendered for delivery with buyers before pairing sellers who have tendered due bills with buyers.

12. The system for fulfilling farmland futures contracts as claimed in claim 9 wherein said means for pairing sellers having approved farmland tendered for delivery with buyers comprises means for pairing sellers having approved farmland tendered for delivery based upon a size designation of said approved farmland tendered for delivery, wherein said approved farmland tendered for delivery having a higher size designation is paired before approved farmland tendered for delivery having a lower size designation.

13. The system for fulfilling farmland futures contracts as claimed in claim 10 wherein said means for pairing sellers who have tendered due bills with buyers comprises means for pairing sellers who have tendered due bills based upon a size designation of said due bill, wherein said due bills having a higher size designation are paired before due bills having a lower size designation.

14. The system for fulfilling farmland futures contracts as claimed in claim 9;
wherein said software means for imputing land quality and size designation requirements of said futures contracts comprises means for inputting delivery configuration requirements for said size designation of said futures contracts; and
wherein said software means for determining whether said at least one parcel of land tendered for delivery meets said land quality and size designation requirements of said futures contracts comprises means for determining whether said at least one parcel of land tendered for delivery has an acceptable delivery configuration for said size designation of said futures contract.

15. The system for fulfilling farmland futures contracts as claimed in claim 9 wherein said computer program product for approving farmland tendered for delivery further comprises;
software means for imputing delivery zone requirements for said futures contracts; and
software means for determining whether said at least one parcel of land tendered for delivery meets a delivery zone requirement for a futures contract.

16. A system for settling farmland futures contracts comprising:
a processor; and
a memory onto which is stored at least one computer program product for commoditizing farmland, a computer program product for approving farmland tendered for delivery, a computer program product for pairing buyers and sellers for delivery under said farmland futures contracts, and a computer program product for the settlement of farmland futures contracts;
wherein said computer program product for commoditizing farmland comprises;
software means for inputting selected soil data for a tract of land tendered for delivery;
software means for inputting property boundary line data defining at least one parcel within said tract of land;
software means for overlaying said soil data over at least one of said at least one parcel of land;
software means for analyzing land quality measures based upon said overlay of said soil data over said at least one parcel of land;
software means for classifying said at least one parcel of land based upon a result of said analysis of land quality measures; and
software means for assigning a size designation to said at least one parcel of land;
wherein said computer program product for approving farmland tendered for delivery comprises;
software means for imputing land quality and size designation requirements of said futures contracts; and
software means for determining whether said at least one parcel of land tendered for delivery meets said land quality and size designation requirements of said futures contracts;
wherein said computer program product for pairing buyers and sellers for delivery under said farmland futures contracts comprises;
software means for imputing data corresponding to due bills tendered by sellers;
software means for pairing sellers having approved farmland tendered for delivery with buyers; and
software means for pairing sellers who have tendered due bills with buyers; and
wherein said computer program product for the settlement of farmland futures contracts comprises;
software means for creating and managing trading accounts; and
software means for closing contracts.

17. The system for settling farmland futures contracts as claimed in claim 16, wherein said software means for closing contracts comprises software means for identifying buyers and sellers that were not paired by said computer program product for pairing buyers and sellers, and adjusting balances of trading accounts for said buyers and sellers based upon a market price of a contract on a date of closing.

18. The system for settling farmland futures contracts as claimed in claim 16, wherein said software means for closing contracts comprises software means for identifying when a seller has failed to tender either approved land or a due bill for delivery, and for downwardly adjusting a balance of a trading account owned by said seller by an amount equal to a performance margin.

19. The system for settling farmland futures contracts as claimed in claim 16, wherein said software means for closing contracts comprises software means for accepting an input of terms of a buyout and adjusting balances of trading accounts owned by seller and the buyer based upon said terms of said buyout.

20. The system for settling farmland futures contracts as claimed in claim 16, wherein said software means for closing contracts comprises software means for terminating a due bill at a maturity date and adjusting balances of trading accounts for said buyers and sellers based upon a market price of a contract on a date of closing.

21. The system for settling farmland futures contracts as claimed in claim 16, wherein said software means for closing contracts comprises software means for extending a due bill obligation, and software means for transferring an extension fees from a seller's account to a buyer's account.
